(19) United States
(12) Patent Application Publication
(10) Pub. No.: US 2015/0113029 A1
(43) Pub. Date: Apr. 23, 2015

(54) EFFICIENT INTEGRATOR FOR WRAPPED STATES OF MODEL ELEMENTS

(71) Applicant: The MathWorks, Inc., Natick, MA (US)

(72) Inventors: Robert O. ABERG, South Grafton, MA (US); Aleksandar Bozin, Cambridge (GB)

(73) Assignee: The MathWorks, Inc., Natick, MA (US)

(21) Appl. No.: 14/056,480

(22) Filed: Oct. 17, 2013

(51) Int. Cl. G06F 17/17

(52) U.S. Cl. CPC G06F 17/17
USPC 708/290

(57) ABSTRACT

A device may determine historical state values to be used to calculate a current state value of a wrapped state associated with a model element. The wrapped state may be associated with a range of state values. The device may calculate the current state value of the wrapped state based on the historical state values, and may determine that the current state value is outside of the range of state values. The device may generate a modified current state value based on determining that the current state value is outside of the range of state values. The modified current state value may be within the range of state values. The device may modify a historical state value based on determining that the current state value is outside of the range of state values. The device may provide or store the modified current state value and the modified historical state value.

### BRIEF DESCRIPTION OF THE DRAWINGS

FIGS. 1A and 1B are diagrams of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for determining and storing information regarding a model element associated with a wrapped state;

FIG. 5 is a diagram of an example implementation relating to the example process shown in FIG. 4;

FIG. 6 is a diagram of another example implementation relating to the example process shown in FIG. 4;

FIG. 7 is a flow chart of an example process for modifying a set of historical state values associated with a model element that includes a wrapped state;

FIG. 8 is a diagram of an example implementation relating to the example process shown in FIG. 7;

FIG. 9 is a flow chart of an example process for determining an unwrapped state value based on a wrapping indicator value; and

FIG. 10 is a diagram of an example implementation relating to the example process shown in FIG. 9.

### DETAILED DESCRIPTION

The following detailed description of example implementations refers to the accompanying drawings. The same reference numbers in different drawings may identify the same or similar elements.

An element of a model (e.g., a block in a block diagram model) may be associated with a wrapped state, where the wrapped state can be represented by a range of values (e.g., the range [0°, 360°], where a left brace, [, or a right brace,], indicates that the value adjacent to the brace is included in the range). When an upper boundary of the range (e.g., 360°) is exceeded, the value of the wrapped state may “wrap” to the lower boundary (e.g., 360.01° may be represented as 0.01°, 361° may be represented as 1°, etc.). Such wrapping may introduce avoidable accumulation of numerical error when a solver (e.g., a multi-step integrator) uses historical state values of the wrapped state to determine a current state value. Implementations described herein may reduce or eliminate such errors by modifying historical state values of a wrapped state associated with a model element when the value of the wrapped state wraps around a boundary (e.g., is outside of a range of values representing the wrapped state).

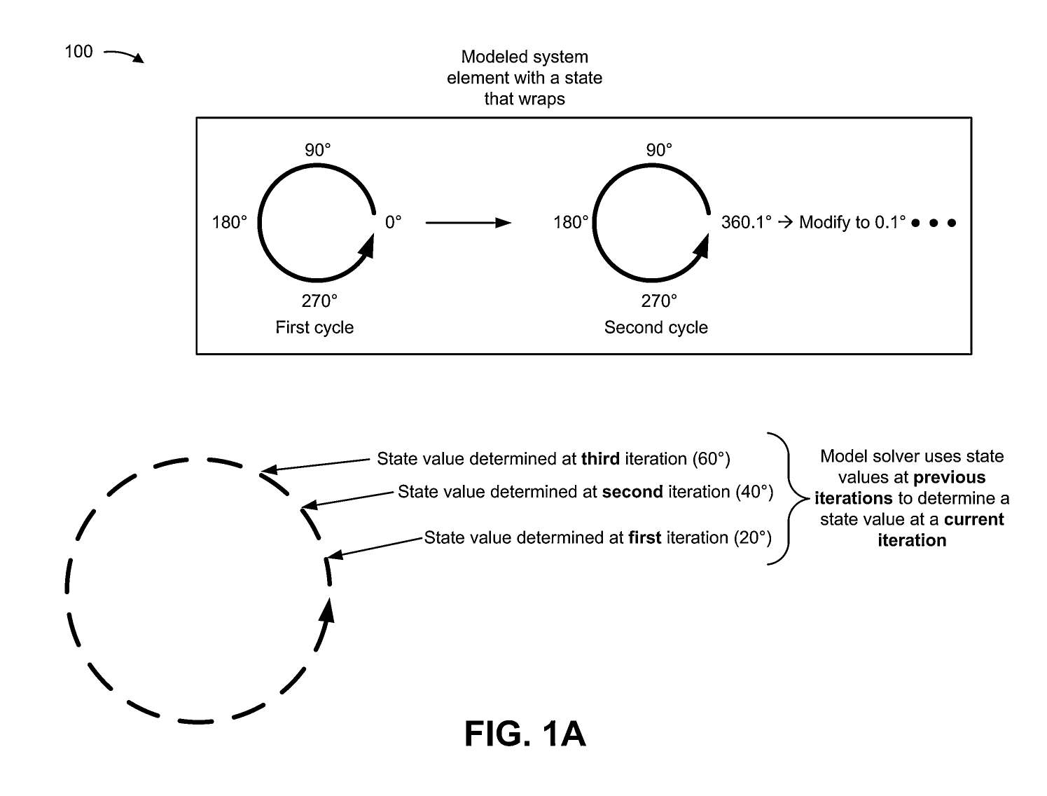

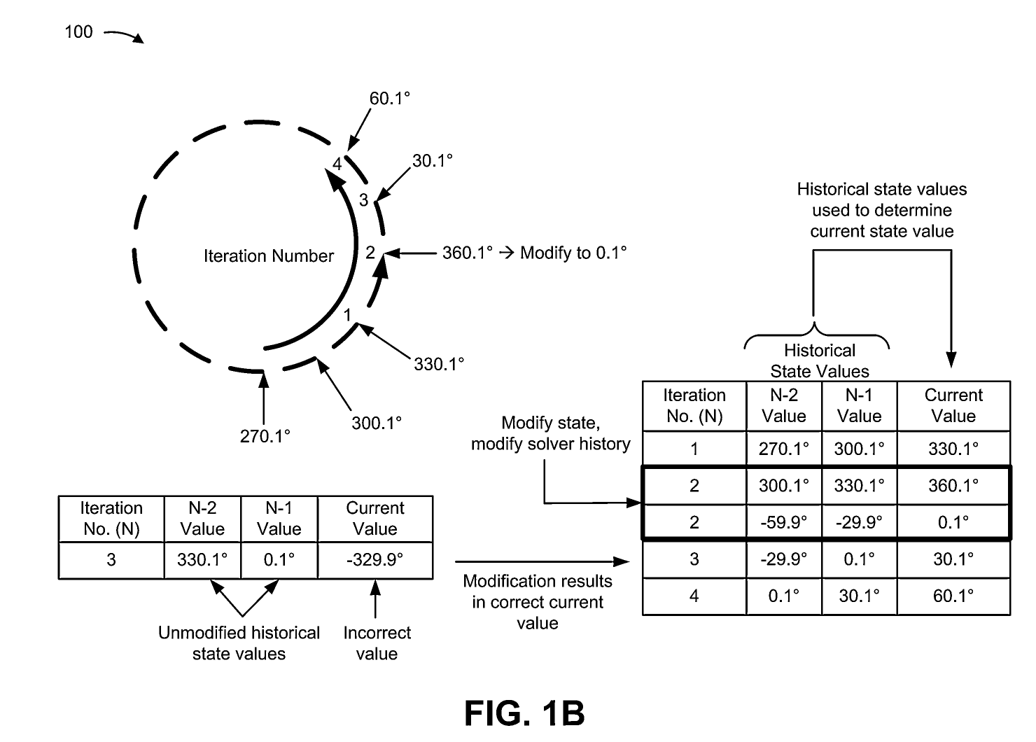

FIGS. 1A and 1B are diagrams of an overview of an example implementation 100 described herein. As shown in FIG. 1A, an element of a model may be associated with a wrapped state with a range of [0°, 360°], as shown by a first cycle of an element modeled using angles of a circle. When the value of the wrapped state exceeds 360° (e.g., 360.01°), as shown by a second cycle, the value of the wrapped state may be modified to fall within the range (e.g., may be modified to 0.01°).

As further shown in FIG. 1A, a model solver (sometimes referred to herein as a “solver”) may be used to determine a state value of the wrapped state. The solver may use state values determined during previous solver iterations (e.g., historical state values) to determine a state value of the wrapped state at the current iteration. For example, the solver may use a state value determined during a first iteration (e.g., 20°) and a state value determined during a second iteration (e.g., 40°) to determine a state value at a third iteration (e.g., 60°). This solver technique may produce an incorrect result when a state value of the wrapped state wraps across a boundary.

As shown in FIG. 1B, error introduced into a solver due to wrapping of state values may be reduced or eliminated by modifying historical state values (e.g., stored in memory) when the state value of the wrapped state wraps across a boundary (e.g., is greater than an upper boundary, is less than a lower boundary). As further shown in FIG. 1B, assume that a solver uses two historical state values to determine a current state value for a wrapped state with a range of [0°, 360°]. For example, for an iteration labeled as “1”, the solver determines a current state value of 330.1° based on two historical state values of 270.1° and 300.1° (270.1°→300.1°→330.1°). Similarly, for an iteration labeled as “2”, the solver determines a current state value of 360.1° based on two historical state values of 300.1° and 330.1° (300.1°→330.1°→360.1°). Because the current state value of 360.1° exceeds the range of [0°, 360°], the solver modifies the current state value to 0.1° so that it is within the range. The solver may also modify (e.g., replace in memory) the historical state values of 300.1° and 330.1° to −59.9° and −29.9°, respectively (−59.9°→-29.9°→0.1°), as shown.

As further shown in FIG. 1B, if the historical state values are not modified, the solver produces an incorrect value of −329.9° for the next iteration (labeled as “3”) based on the historical state values of 330.1° and 0.1° (330.1°→0.1°→-329.9). Modifying the historical state values during iteration 2 (e.g., from 300.1° to −59.9° and from 330.1° to −29.9°), eliminates the error associated with this incorrect state value, and produces a correct state value of 30.1° (−29.9°→0.1°→30.1°) for the current state during iteration 3, as shown. The solver may continue to determine state values in this manner, modifying a current state value to generate a modified current state value, and modifying historical state values to produce modified historical state values, when the current state value falls outside a range associated with a wrapped state. In this way, error introduced into a solver due to wrapping of state values may be reduced or eliminated.

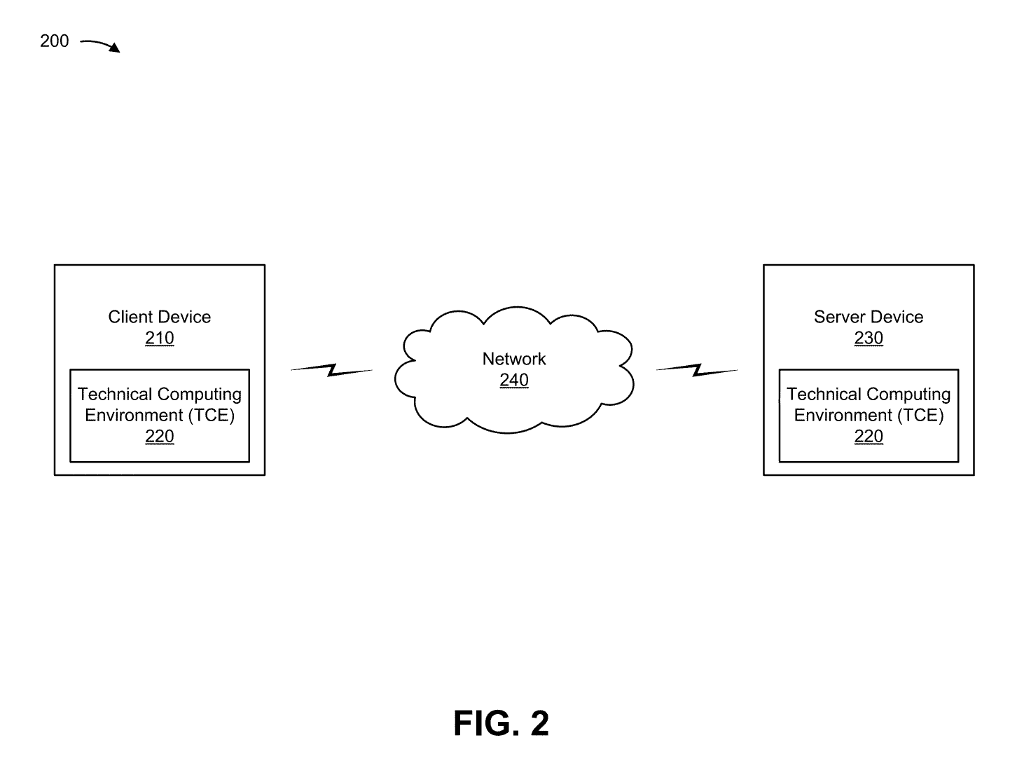

FIG. 2 is a diagram of an example environment 200 in which systems and/or methods described herein may be implemented. As shown in FIG. 2, environment 200 may include a client device 210, which may include a technical computing environment (TCE) 220. Furthermore, environment 200 may include a server device 230, which may include TCE 220, and a network 240. Devices of environment 200 may interconnect via wired connections, wireless connections, or a combination of wired and wireless connections.

Client device 210 may include a device capable of receiving, generating, storing, processing, executing, and/or providing information associated with a model element (e.g., a model element associated with a wrapped state). For example, client device 210 may include a computing device, such as a desktop computer, a laptop computer, a tablet computer, a handheld computer, a server, a mobile phone (e.g., a smart phone, a radiotelephone, etc.), or a similar device. In some implementations, client device 210 may receive information from and/or transmit information to server device 230 (e.g., information associated with the model element).

Client device 210 may host TCE 220. TCE 220 may include any hardware-based logic or a combination of hardware and software-based logic that provides a computing environment that allows tasks to be performed (e.g., by users) related to disciplines, such as, but not limited to, mathematics, science, engineering, medicine, and business. TCE 220 may include a text-based environment (e.g., MATLAB® software), a graphically-based environment (e.g., Simulink® software, Stateflow® software, SimEvents® software, etc., by The MathWorks, Inc.; VisSim by Visual Solutions; LabView® by National Instruments; Agilent VEE by Agilent Technologies; Advanced Design System (ADS) by Agilent Technologies; Agilent Ptolemy by Agilent Technologies; etc.), or another type of environment, such as a hybrid environment that may include, for example, a text-based environment and a graphically-based environment.

TCE 220 may include, for example, a text environment (e.g., a text editor) and/or a graphical environment (e.g., a graphical user interface) capable of modeling an element of a system using a wrapped state. The model element may include, for example, a block (e.g., in a block diagram model), a state (e.g., a value that represents a state of the model element), an equation (e.g., a kinematic equation), program code (e.g., that may be executed to determine a state value of the wrapped state), or the like. Additionally, or alternatively, TCE 220 may use a solver to determine a state value of the wrapped state. The solver may, for example, execute a series of instructions to determine the state value. As an example, the solver may include an ordinary differential equation (ODE) solver, a differential algebraic equation (DAE) solver, or the like. Additionally, or alternatively, the solver may include a multi-step solver that uses two or more historical state values (e.g., stored in memory) of the wrapped state to calculate the current state value of the wrapped state. For example, a two-step solver may use two historical state values to calculate the current state value, a three-step solver may use three historical state values to calculate the current state value, etc.

Server device 230 may include one or more devices capable of receiving, generating, storing, processing, executing, and/or providing information associated with a model element. For example, server device 230 may include a computing device, such as a server, a desktop computer, a laptop computer, a tablet computer, a handheld computer, or a similar device. In some implementations, server device 230 may host TCE 220.

Network 240 may include one or more wired and/or wireless networks. For example, network 240 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

The number of devices and/or networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

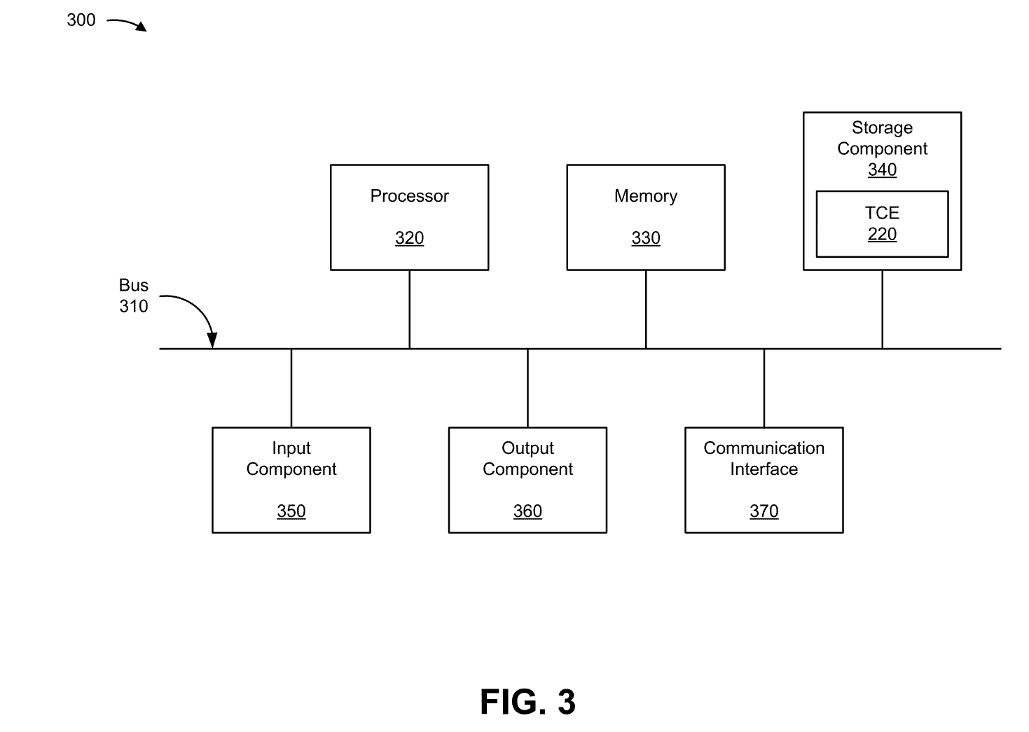

FIG. 3 is a diagram of example components of a device 300, which may correspond to client device 210 and/or server device 230. In some implementations, each of client device 210 and/or server device 230 may include one or more devices 300 and/or one or more components of device 300. As shown in FIG. 3, device 300 may include a bus 310, a processor 320, a memory 330, a storage component 340, an input component 350, an output component 360, and a communication interface 370.

Bus 310 may include a path that permits communication among the components of device 300. Processor 320 may include a processor (e.g., a central processing unit, a graphics processing unit, an accelerated processing unit, etc.), a microprocessor, and/or any processing component (e.g., a field-programmable gate array (FPGA), an application-specific integrated circuit (ASIC), etc.) that interprets and/or executes instructions, and/or that is designed to implement a particular function. In some implementations, processor 320 may include multiple processor cores for parallel computing. Memory 330 may include a random access memory (RAM), a read only memory (ROM), and/or another type of dynamic or static storage component (e.g., a flash, magnetic, or optical memory) that stores information and/or instructions for use by processor 320.

Storage component 340 may store information and/or software related to the operation and use of device 300. For example, storage component 340 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive. In some implementations, storage component 340 may store TCE 220.

Input component 350 may include a component that permits a user to input information to device 300 (e.g., a touch screen display, a keyboard, a keypad, a mouse, a button, a switch, etc.). Output component 360 may include a component that outputs information from device 300 (e.g., a display, a speaker, one or more light-emitting diodes (LEDs), etc.).

Communication interface 370 may include a transceiver-like component, such as a transceiver and/or a separate receiver and transmitter, that enables device 300 to communicate with other devices, such as via a wired connection, a wireless connection, or a combination of wired and wireless connections. For example, communication interface 370 may include an Ethernet interface, an optical interface, a coaxial interface, an infrared interface, a radio frequency (RF) interface, a universal serial bus (USB) interface, a high-definition multimedia interface (HDMI), or the like.

Device 300 may perform various operations described herein. Device 300 may perform these operations in response to processor 320 executing software instructions included in a computer-readable medium, such as memory 330 and/or storage component 340. A computer-readable medium may be defined as a non-transitory memory device. A memory device may include memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided as an example. In practice, device 300 may include additional components, fewer components, different components, or differently arranged components than those shown in FIG. 3. Additionally, or alternatively, one or more components of device 300 may perform one or more functions described as being performed by another one or more components of device 300.

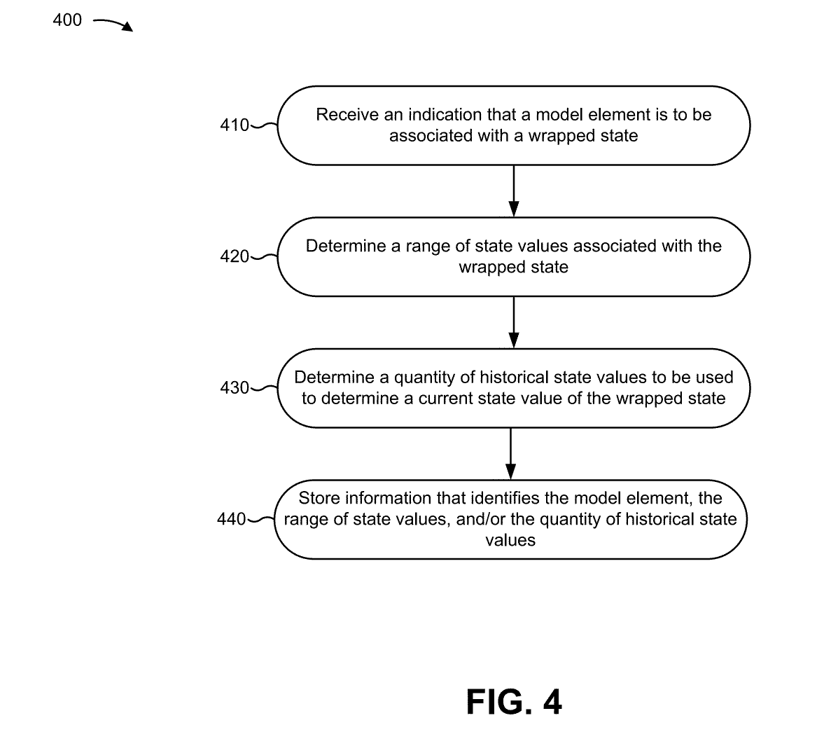

FIG. 4 is a flow chart of an example process 400 for determining and storing information regarding a model element associated with a wrapped state. In some implementations, one or more process blocks of FIG. 4 may be performed by client device 210. In some implementations, one or more process blocks of FIG. 4 may be performed by another device or a group of devices separate from or including client device 210, such as server device 230.

As shown in FIG. 4, process 400 may include receiving an indication that a model element is to be associated with a wrapped state (block 410). For example, client device 210 may receive (e.g., via input from a user and/or from another device) an indication that a model element is to be associated with a wrapped state.

A model element may refer to an element of a model that, when executed, simulates a behavior of a physical system and/or performs a computing task or a set of computing tasks. For example, a model element may include program code (e.g., a block of code, a function, a method, a variable, etc.), a graphical feature (e.g., in a graphical modeling environment), a block in a block diagram modeling environment, a block parameter (e.g., a port, a signal, a state, etc.), an object in a workspace (e.g., TCE 220), an equation (e.g., a kinematic equation), or the like. In some implementations, the model element may represent an integration operation performed on a kinematic equation of a dynamic system, such as a mechanical system (e.g., the model element may represent an angular velocity of rotating machinery), an electrical phase system (e.g., the model element may represent a phasor angle), a clock system (e.g., the model element may represent time, which may wrap from seconds to minutes, minutes to hours, etc.), a calendar system (e.g., the model element may represent time expressed in days, and may wrap days in a week), or the like.

The model element may be associated with a wrapped state. A wrapped state may refer to a state that can be represented by a range of state values (e.g., a finite range of state values). Each state value, in the range of state values, may represent a potential state value that describes a behavior of the wrapped state and/or the model element. When an upper boundary of the range is exceeded, the state value of the wrapped state may wrap to the lower boundary. Likewise, when the lower boundary of the range is exceeded, the state value of the wrapped state may wrap to the higher boundary.

In some implementations, the wrapped state may include a cyclic state that includes a range of angles of a circle as potential state values. The angles may be expressed in degrees (e.g., [0°, 360°], [−180°, 180°], [0°, 360°), (0°, 36020 ], [−180°, 180°), (−180°, 180°], etc., where a left brace, [, or a right brace,], indicates that the value adjacent to the brace is included in the range, and where a left parenthesis, (, or a right parenthesis,), indicates that the value adjacent to the brace is not included in the range), radians (e.g., [−π radians, π radians], [0 radians, 2π radians], (0 radians, 2π radians], etc.), circles (e.g., [0 circles, 1 circle]), semi-circles (e.g., [−1 semi-circle, 1 semi-circle]), or any other unit of measurement capable of representing angles. The upper boundary and the lower boundary of the range of state values may represent the same state (e.g., 0° and 360° may represent the same state), in some implementations. The range of angles may represent a full circle (e.g., a lower boundary of 0° and an upper boundary of 360°), may represent a portion of a circle (e.g., a lower boundary of 60° and an upper boundary of) 120°, or may represent more than a circle (e.g., a lower boundary of 0° and an upper boundary of 450°).

Additionally, or alternatively, the wrapped state may include a periodic state that traverses a range of values in a constant amount of time. The range of values may include a continuous range of values (e.g., a continuous range of integer values with a lower boundary of 1 and an upper boundary of 10), may include a discrete range of values (e.g., hour values of 1 to 12 on a digital clock), or may include a combination of a continuous range of values and a discrete range of values (e.g., a continuous range of values from 1 to 100, and discrete values of 200, 400, 600, 800, and 1000).

Client device 210 may receive an indication that a model element is to be associated with a wrapped state by receiving input from a user, in some implementations. For example, client device 210 may provide a user interface (e.g., via TCE 220) that permits a user to input the indication by use of an input mechanism (e.g., a button, a checkbox, etc.). The user may provide input indicating a particular model element, and may provide input indicating that the particular model element is to be associated with a wrapped state. In some implementations, the user may provide input indicating that the particular model element is to be associated with a cyclic state or a periodic state. For example, the user may select a block in a block diagram modeling environment, and may select a checkbox indicating that the block is to be associated with a wrapped state. Client device 210 may provide an indication (e.g., on the user interface) that the block is to be associated with the wrapped state.

Additionally, or alternatively, client device 210 (e.g., TCE 220) may provide a model element that is to be associated with a wrapped state by default. For example, client device 210 may provide a block and/or a library of blocks with a default attribute that associates the block(s) with a wrapped state. Client device 210 may provide an indication that the block(s) are associated with the wrapped state by default, such as by providing an icon displayed on the block. A user may select a provided model element (e.g., by selecting a block with the icon), and client device 210 may receive the selection as an indication that the model element is to be associated with the wrapped state. Additionally, or alternatively, a model element may be associated with a cyclic state or a periodic state by default.

In some implementations, client device 210 may receive an indication (e.g., based on user input) of whether or not a wrapped state may be ignored when performing a trim operation on a modeled system. A trim operation may be performed to compute a steady-state operating point (e.g., an equilibrium point) of the modeled system. For example, a user may provide an indication that a wrapped state is a periodic state to indicate that a value of the wrapped (periodic) state is not to be determined when performing the trim operation (e.g., is to be ignored when performing the trim operation). When performing a trim operation on a model element (e.g., an integrator) that includes a periodic state, client device 210 may trim the input to the model element (e.g., a derivative value) to a constant value. In some implementations, the user may provide an indication that a wrapped state is a cyclic state to indicate that a value of the wrapped (cyclic) state is to be determined when performing the trim operation (e.g., the value is to be determined, when performing the trim operation, to specify a steady-state operating point of the cyclic state in the modeled system).

As further shown in FIG. 4, process 400 may include determining a range of state values associated with the wrapped state (block 420). For example, client device 210 may determine (e.g., via receiving user input) a range of state values that can be used to represent a state of the wrapped state. The range of state values may include an upper boundary value (e.g., a largest value included in the range) and a lower boundary value (e.g., a smallest value included in the range), in some implementations.

In some implementations, client device 210 may receive (e.g., via input from a user and/or from another device) information that identifies the range of state values. For example, client device 210 may provide a user interface (e.g., via TCE 220) that permits a user to input information identifying the range of state values via an input mechanism (e.g., a text box, a list box, a drop-down box, etc.). The user may provide input identifying the range of state values. Client device 210 may receive the input, and may associate the identified range of state values with the wrapped state and/or the model element.

Additionally, or alternatively, client device 210 (e.g., TCE 220) may provide a model element that is to be associated with a default range of state values. For example, client device 210 may provide a block and/or a library of blocks with a default attribute that associates the block(s) with a range of state values. Client device 210 may provide an indication that the block(s) are associated with the default range of state values, such as by providing an icon displayed on the block. A user may select a provided model element (e.g., by selecting a block with the icon), and client device 210 may receive the selection as an indication that the wrapped state and/or the model element is to be associated with the default range of state values.

As further shown in FIG. 4, process 400 may include determining a quantity of historical state values to be used to determine a current state value of the wrapped state (block 430). For example, client device 210 may determine (e.g., via receiving user input) a quantity of historical state values to be used to determine a current state value of the wrapped state.

A historical state value may refer to a value used to determine a current state value of the wrapped state. A historical state value may have been determined to be a previous state value of a previous iteration of an iterative simulation of a model. For example, client device 210 may simulate a time-based model, such as a model that estimates the position of a moving object over time. Client device 210 may use a position of the object at a first time (e.g., determined during a first iteration) to estimate a position of the object at a later time (e.g., determined during a later iteration). In some implementations, client device 210 may use a position of the object determined during multiple previous iterations (e.g., multiple historical state values) to determine a position of the object during a current iteration (e.g., a current state value). Client device 210 may store one or more historical state values in memory.

In some implementations, client device 210 may determine a quantity of historical state values based on a solver associated with the model element. A solver may refer to an algorithm that, when executed, calculates the current state value of the wrapped state. The solver may include, for example, an ordinary differential equation (ODE) solver, a differential algebraic equation (DAE) solver, or the like. Additionally, or alternatively, the solver may include a multistep solver that uses two or more historical state values to calculate the current state value. A particular type of solver may use a particular quantity of historical state values to calculate the current state value of the wrapped state, and different types of solvers may use different quantities of historical state values to calculate the current state value of the wrapped state. For example, a two-step solver may use two historical state values to calculate the current state value of the wrapped state, a three-step solver may use three historical state values to calculate the current state value of the wrapped state, etc.

In some implementations, client device 210 may determine a type of solver to be used to calculate the current state value based on user input, and may determine the quantity of historical state values based on the type of solver. For example, client device 210 may provide a user interface (e.g., via TCE 220) that permits a user to input information identifying the type of solver via an input mechanism (e.g., a list box, a drop-down box, etc.). The user may provide input identifying the type of solver. Client device 210 may receive the input, and may determine the quantity of historical state values based on the type of solver. For example, if the user selects a two-step solver, client device 210 may determine that two historical state values are to be used to determine the current state value.

Client device 210 may determine a default type of solver, in some implementations. For example, client device 210 may determine a default type of solver associated with a particular type of model, a particular type of model element, a particular type of wrapped state, or the like. Additionally, or alternatively, a user may specify a default type of solver (e.g., to be associated with TCE 220, the type of model, the type of model element, the type of wrapped state, etc.). Client device 210 may determine the quantity of historical state values based on the default type of solver.

Additionally, or alternatively, client device 210 may determine the quantity of historical state values based on receiving information identifying an operating point snapshot. For example, a user may provide input that causes client device 210 to capture an operating point snapshot during a simulation (e.g., execution of a model that includes one or more model elements). The operating point snapshot may capture state values associated with model elements, such as a quantity of historical state values being used by one or more solvers when the operating point snapshot is captured, and/or a value of the captured historical state values. The user may wish to apply the operating point snapshot to another simulation, and may provide input identifying the operating point snapshot. Client device 210 may determine the captured quantity of historical state values and/or the values of the captured historical state values based on the operating point snapshot.

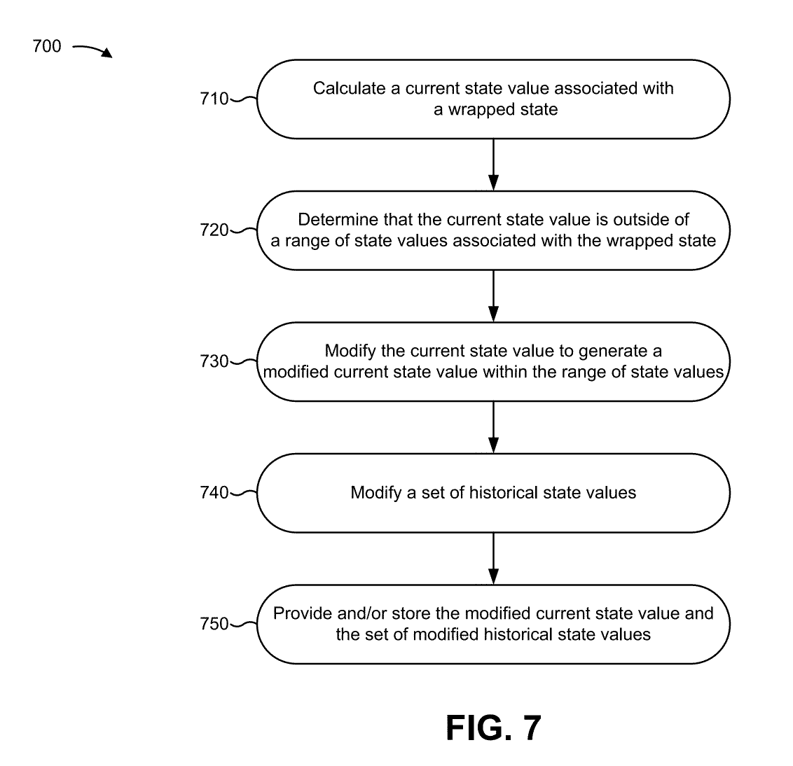

As further shown in FIG. 4, process 400 may include storing information that identifies the model element, the range of state values, and/or the quantity of historical state values (block 440). For example, client device 210 may store (e.g., in memory), information that identifies the model element (e.g., an indication that the model element is to be associated with a wrapped state), information that identifies the range of state values associated with the wrapped state, and/or information that identifies the quantity of historical state values to be used to determine the current state value of the wrapped state. Client device 210 may store this information for later use (e.g., for use in connection with process 700, described herein in connection with FIG. 7).

Although FIG. 4 shows example blocks of process 400, in some implementations, process 400 may include additional blocks, fewer blocks, different blocks, or differently arranged blocks than those depicted in FIG. 4. Additionally, or alternatively, one or more of the blocks of process 400 may be performed in parallel.

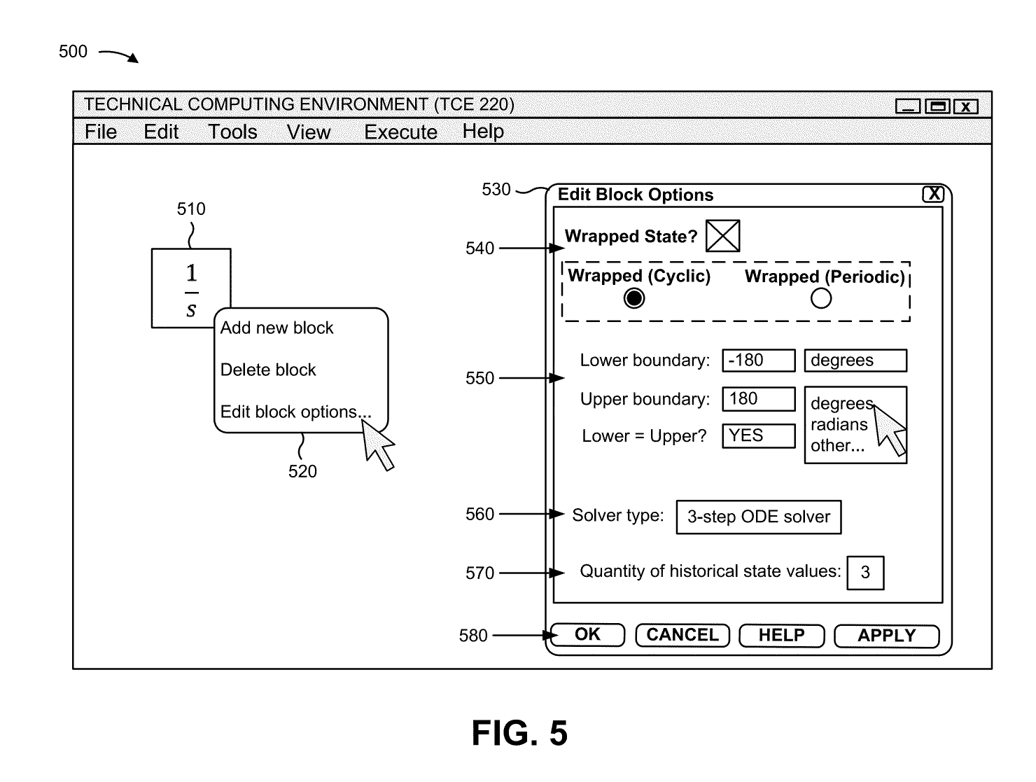

FIG. 5 is a diagram of an example implementation 500 relating to example process 400 shown in FIG. 4. FIG. 5 depicts an example where client device 210 receives user input, via TCE 220, to identify a range of state values associated with a wrapped state of a model element, and to identify a quantity of historical state values to be used to determine a current state value of the wrapped state.

As shown in FIG. 5, and by reference number 510, assume that a user selects a block in a block diagram model, and further selects to edit options associated with the block, as shown by reference number 520. Further, assume that user selection of “Edit block options” causes TCE 220 to provide an edit block options user interface 530. Edit block options user interface 530 may permit the user to provide input indicating that the selected block is to be associated with a wrapped state (reference number 540), input identifying a range of state values of the wrapped state (reference number 550), input identifying a solver type for calculating a current state value of the wrapped state (reference number 560), and input identifying a quantity of historical state values to be used when calculating the current state value (reference number 570).

As further shown in FIG. 5, and by reference number 540, assume that the user marks a check box to indicate that the selected block is to be associated with a wrapped state. Further, assume that the user specifies that the wrapped state is a cyclic wrapped state rather than a periodic wrapped state. As shown by reference number 550, assume that the user selects a lower boundary value of −180° and an upper boundary value of 180° for the range of state values to be used to represent states of the wrapped state. Further, assume that the user has indicated that the lower boundary value of −180° represents the same state as the upper boundary value of 180°. As shown by reference number 560, assume that the user has selected a three-step ODE solver as the solver type to be used to calculate the current state value of the wrapped state.

As shown by reference number 570, assume that client device 210 determines that the three-step ODE solver uses three historical state values to determine the current state value of the wrapped state, and provides an indication of the quantity of historical state values (e.g., 3). In some implementations, the user may be permitted to directly input the quantity of historical state values. Additionally, or alternatively, the user may indirectly input the quantity of historical state values by selecting a solver type, and client device 210 may determine the quantity of historical state values based on the selected solver type.

As shown by reference number 580, the user may interact with an “OK” button to indicate that the user has finished providing input. Based on user interaction with the “OK” button, client device 210 may store the information input by the user (e.g., displayed on edit block options user interface 530) for later use.

As indicated above, FIG. 5 is provided merely as an example. Other examples are possible and may differ from what was described with regard to FIG. 5.

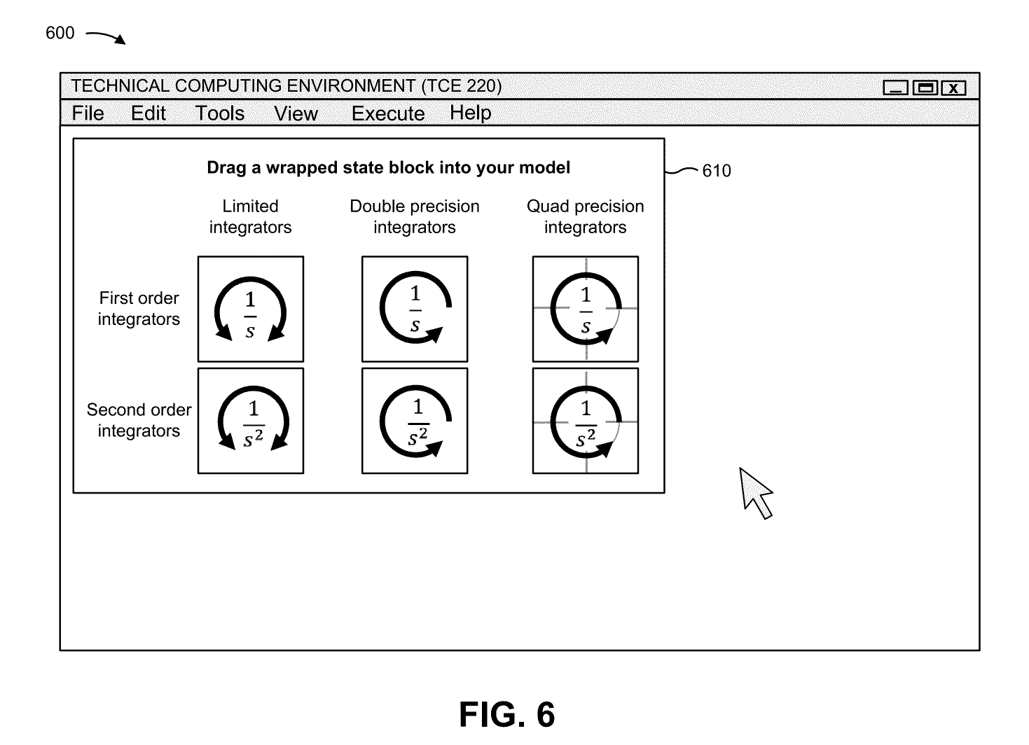

FIG. 6 is a diagram of an example implementation 600 relating to example process 400 shown in FIG. 4. FIG. 6 depicts an example where client device 210 receives user input, via TCE 220, identifying a block that is associated with a default range of state values and a default quantity of historical state values.

As shown in FIG. 6, and by reference number 610, client device 210 may provide (e.g., via TCE 220) a library of blocks that may be used in a block diagram model. A user may interact with the library of blocks to select a block to be included in a block diagram model, such as by clicking and dragging a block from a portion of a user interface associated with the library to a portion of the user interface associated with the model. The library may include blocks with different attributes, such as blocks that perform different types of calculations (e.g., first order integration, second order integration, etc.), blocks that perform calculations over different ranges of state values (e.g., limited integrators, cyclic integrators, periodic integrators, etc.), blocks that perform calculations with different precisions (e.g., double precision integrators, quad precision integrators, etc.), or the like. Client device 210 may depict icons on the blocks to indicate attributes of the blocks. Client device 210 may determine the range of state values and the quantity of historical state values based on user selection of a particular type of block.

As indicated above, FIG. 6 is provided merely as an example. Other examples are possible and may differ from what was described with regard to FIG. 6.

FIG. 7 is a flow chart of an example process 700 for modifying a set of historical state values associated with a model element that includes a wrapped state. In some implementations, one or more process blocks of FIG. 7 may be performed by client device 210. In some implementations, one or more process blocks of FIG. 7 may be performed by another device or a group of devices separate from or including client device 210, such as server device 230.

As shown in FIG. 7, process 700 may include calculating a current state value associated with a wrapped state (block 710). For example, client device 210 may calculate (e.g., using a solver) a current state value associated with the wrapped state. Client device 210 may calculate the current state value based on one or more historical state values, in some implementations. For example, client device 210 may use a multi-step solver to calculate the current state value, which may use two or more historical state values (e.g., stored in memory) to calculate the current state value. Client device 210 may determine the solver and/or the quantity of historical state values, used to calculate the current state value, as described herein in connection with FIG. 4. In some implementations, client device 210 may use one or more other values to calculate the current state value, such as an input value (e.g., input to a model element that includes the wrapped state, such as a derivative to be integrated), a Jacobian matrix that describes a relationship between one or more other states in a model and the wrapped state, or the like.

In some implementations, client device 210 may adjust a numbering scheme used to represent a current state value, a range of state values, or the like, to make calculations described herein more efficient. For example, client device 210 may modify a complex numbering scheme (e.g., that includes a real number and an imaginary number) to a phasor numbering scheme (e.g., that includes a magnitude value and a phase value).

As further shown in FIG. 7, process 700 may include determining that the current state value is outside of a range of state values associated with the wrapped state (block 720). For example, client device 210 may determine that the calculated current state value is outside of a range of state values (e.g., is greater than an upper boundary value, is less than a lower boundary value, is equal to an upper or lower boundary value, etc.) associated with the wrapped state.

Client device 210 may determine that the current state value is outside of the range of state values by comparing the current state value to one or more boundary values associated with the range (e.g., an upper boundary value, a lower boundary value, etc.). If the current state value satisfies a threshold defined by a boundary value, then client device 210 may determine that the current state value is outside of the range. For example, if the current state value is greater than an upper boundary value of the range, then client device 210 may determine that the current state value is outside of the range. Additionally, or alternatively, if the current state value is less than a lower boundary value of the range, then client device 210 may determine that the current state value is outside of the range.

In some implementations, client device 210 may perform a zero-crossing determination before or after calculating the current state value and/or determining that the current state value is outside of the range. The zero-crossing determination may detect a point in time at which a state value of the wrapped state crossed a first boundary of the range (e.g., was equal to and/or exceeded the first boundary value) and wrapped to a second boundary of the range.

In some implementations, client device 210 may perform a Nyquist diagnostic based on calculating the current state value and/or determining that the current state value is outside of the range. The Nyquist diagnostic may ensure that at least two iterations of calculating a current state value are performed without either of the at least two calculated current state values exceeding the range of state values (e.g., to ensure that at least two samples are taken per cycle). To perform the Nyquist diagnostic, client device 210 may calculate a difference between two consecutively calculated current state values. If the difference is greater than or equal to the size of the range of state values, then client device 210 may provide an indication that the sample size is too large, which may lead to aliased results because the simulation violated the Nyquist sampling criterion. Additionally, or alternatively, client device 210 may provide the indication if more than one wrap occurs per two samples. In some implementations, client device 210 may recommend a particular sample size or a range of sample sizes (e.g., a time step for calculating current state values) based on the difference and/or the size of the range.

In some implementations, client device 210 may determine that the current state value is within the range of state values associated with the wrapped state. In this case, client device 210 may provide the current state value and a set of historical state values as input to a solver. For example, the solver may use the current state value and/or the set of historical state values (or a portion of the set of historical state values) to determine a current state value for a next iteration. Additionally, or alternatively, client device 210 may store the current state value and the set of historical state values (or a portion of the set of historical state values) in memory for later use (e.g., by a solver).

As further shown in FIG. 7, process 700 may include modifying the current state value to generate a modified current state value within the range of state values (block 730). For example, client device 210 may modify the current state value, based on determining that the current state value is outside of the range of state values, to generate a modified current state value that is within the range of state values.

In some implementations, client device 210 may determine a difference amount by which the current state value exceeds (e.g., is outside of) a first boundary value of the range (e.g., a difference between the current state value and the first boundary value). Client device 210 may generate a modified current state value based on a second boundary value of the range and further based on the difference amount. In some implementations, client device 210 may set the modified current state value equal to a value that is within the range and differs from the second boundary value by the difference amount. For example, given a range of [0°, 360°], assume that client device 210 calculates the current state value as 365°, which exceeds the upper boundary of 360° by an amount of 5° (e.g., the difference between 365° and 360° is 5°). Client device 210 may set the modified current state value equal to 5°, which is equal to the lower boundary value of 0° plus the amount (e.g., the difference) of 5°.

Additionally, or alternatively, client device 210 may modify the current state value using a modulo operation. Client device 210 may perform the modulo operation by taking the current state value modulo the size of the range of state values to generate a modulo value. Additionally, or alternatively, client device 210 may perform the modulo operation by determining the distance between the current state value and the closest boundary, and by taking the distance modulo the size of the range. Client device 210 may calculate the modified current state value as a value, within the range, that is equal to the difference between the modulo value and a boundary of the range. The size of the range (or range size) may be equal to a quantity of unique state values included in the range, a difference between an upper boundary value and a lower boundary value of the range, or the like.

When the current state value exceeds the upper boundary value of the range, client device 210 may add the modulo value to the lower boundary value of the range to generate the modified current state value. For example, given a range of [0°, 360°], assume that client device 210 calculates a current state value of 390°. Client device 210 may determine that the modulo value is equal to 30° (390° modulo 360°=30°, or (390°-360°) modulo 360°=30°), and may add the modulo value of 30° to the lower boundary value of 0° to generate a modified state value of 30°.

When the current state value exceeds the lower boundary value of the range, client device 210 may subtract the modulo value from the upper boundary value of the range to generate the modified current state value. For example, given a range from 0° to 360°, assume that client device 210 calculates a current state value of −10°. Client device 210 may determine that the modulo value is equal to 10° (10° modulo 360°=10°, or (10°-0°) modulo 360°=10°), and may subtract the modulo value of 10° from the upper boundary value of 360° to generate a modified state value of 350°.

As further shown in FIG. 7, process 700 may include modifying a set of historical state values (block 740). For example, client device 210 may modify a set of historical state values based on determining that the current state value is outside of the range of state values associated with the wrapped state. In some implementations, client device 210 may modify a historical state value such that a first distance between the historical state value and the current state value is equal to a second distance between the modified historical state value and the modified current state value.

In some implementations, client device 210 may modify a quantity of historical state values based on a quantity of historical state values used to determine the current state value. For example, client device 210 may execute a three-step solver, which uses three historical state values to calculate the current state value, and may therefore modify three historical state values. Client device 210 may determine the solver and/or the quantity of historical state values, used to calculate the current state value, as described herein in connection with FIG. 4. Alternatively, client device 210 may modify two historical state values for a three-step solver, since the three-step solver may use the current state value and two historical state values (three total state values) to determine a state value of a next iteration.

In some implementations, client device 210 may modify a historical state value by adding or subtracting a modification value to or from the historical state value, where the modification value is equal to a difference between the current state value and the modified current state value. For example, given a range of [0°, 360°], assume that client device 210 calculates a current state value of 365° based on a first historical state value of 345° and a second historical state value of 355° (345°→355°→365°). Further, assume that client device 210 determines a modified current state value of 5° by wrapping the value of 365° around the range of state values (345°→355°→5°). Client device 210 may determine a difference of 360° between the current state value of 365° and the modified current state value of 5°. Client device 210 may subtract the difference from the historical state values to generate a first modified historical state value of −15° (345°−360°=−15°) and a second modified historical state value of −5° (355°−360°=−5°). Client device 210 may use one or more modified historical state values and/or the modified current state value to determine a current state value of 15° for a next iteration (e.g., −5°→5°→15°).

As shown by the example above, client device 210 may use M historical state values to calculate a current state value for a next iteration (e.g., M=2 for a two-step solver, M=3 for a three-step solver, etc.). Client device 210 may modify M−1 historical state values for the next iteration, and may use the M−1 modified historical state values and the current state value of the current iteration to determine a new current state value for the next iteration.

In some implementations, the modification value may be equal to the size of the range. When the current state value exceeds the upper boundary of the range, client device 210 may subtract the modification value from one or more historical state values. When the current state value exceeds the lower boundary of the range, client device 210 may add the modification value to one or more historical state values.

As further shown in FIG. 7, process 700 may include providing and/or storing the modified current state value and the set of modified historical state values (block 750). For example, client device 210 may provide (e.g., for display) and/or may store (e.g., in memory) the modified current state value and the set of modified historical state values.

In some implementations, client device 210 may provide the modified current state value for further processing. For example, client device 210 may provide the modified current state value to another model element, which may execute based on the modified current state value. In some implementations, client device 210 may trigger an event based on the modified current state value. For example, if the modified current state value satisfies a threshold, client device 210 may trigger an event associated with a model and/or a system represented by the model.

In some implementations, client device 210 may provide the modified current state value and the set of modified historical state values as input to a solver. For example, the solver may use the modified current state value and/or the set of modified historical state values (or a portion of the set of modified historical state values) to determine a current state value for a next iteration. Additionally, or alternatively, client device 210 may store the modified current state value and the set of modified historical state values (or a portion of the set of modified historical state values) in memory for later use (e.g., by a solver). In this way, client device 210 may reduce or eliminate errors associated with using historical state values to calculate a current state value for a wrapped state.

Although FIG. 7 shows example blocks of process 700, in some implementations, process 700 may include additional blocks, fewer blocks, different blocks, or differently arranged blocks than those depicted in FIG. 7. Additionally, or alternatively, one or more of the blocks of process 700 may be performed in parallel.

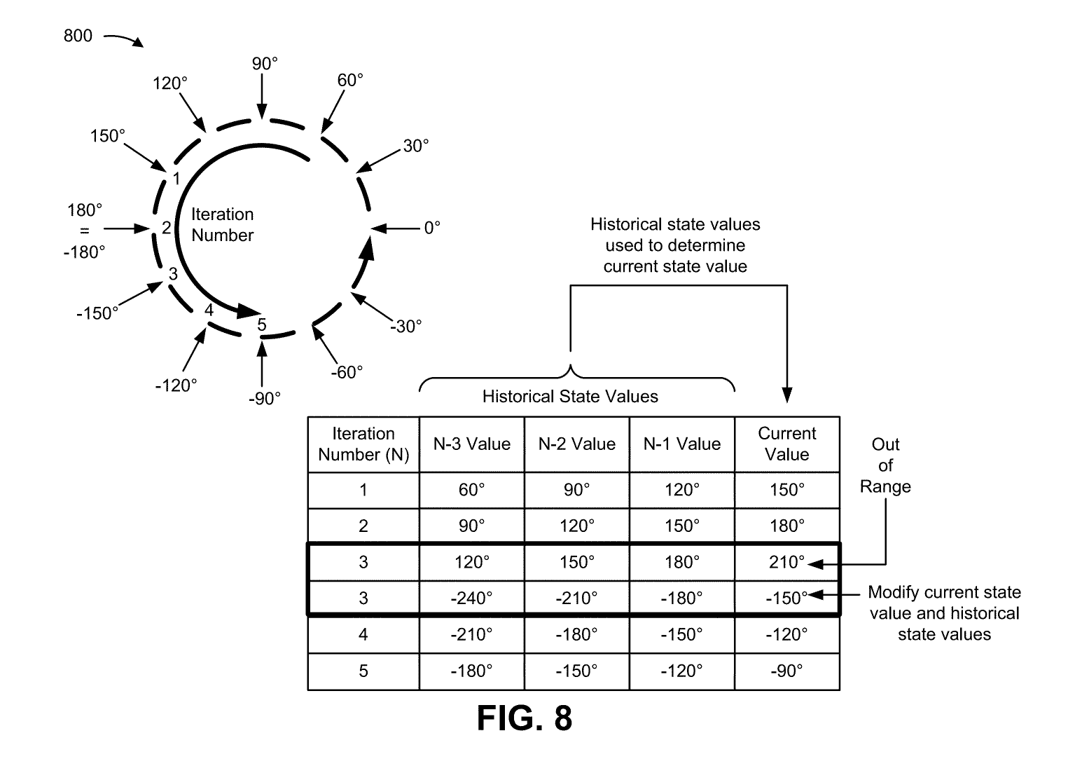

FIG. 8 is a diagram of an example implementation 800 relating to example process 700 shown in FIG. 7. For example implementation 800, assume that client device 210 uses a three-step solver to calculate a current state value for a wrapped state with potential state values in the range [480°, 180°].

As shown in FIG. 8, assume that during a first iteration, client device 210 uses three historical state values of 60°, 90°, and 120° to determine a current state value of 150° (60°→90°→120°→150°), which is within the range. Further, assume that during a second iteration, client device 210 uses three historical state values of 90°, 120°, and 150° to determine a current state value of 180° (90°→120°→150°→180°), which is also within the range. Assume that during a third iteration, client device 210 uses three historical state values of 120°, 150°, and 180° to determine a current state value of 210° (120°→150°→180°→210°), which is outside of the range.

Based on determining that the current state value of 210° is outside of the range, client device 210 may determine that the current state value of 210° exceeds the upper boundary value of the range (180°) by 30°. Client device 210 may add the difference amount of 30° to the lower boundary value of the range (−180°) to generate a modified current state value of −150°, as shown. Alternatively, client device 210 may calculate the difference amount (30°) modulo the size of the range (360°) to generate a modulo value of 30° (30° modulo 360°=30°) (in this example, the modulo value is equal to the difference amount).

As further shown, client device 210 may determine a difference between the current state value of 210° and the modified current state value of −150° to be 360° (210°−−150°=360°). Client device 210 may subtract this difference of 360° from the historical state values used during the third iteration to determine modified historical state values. For example, client device 210 may modify 120° to −240°, may modify 150° to −210°, and may modify 180° to −180°, as shown.

Client device 210 may use the modified current state value (−150°) and one or more of the modified historical state values (−240°, −210°, and −180°) to determine a current state value during a fourth iteration. For example, assume that during the fourth iteration, client device 210 uses the historical state values of −210° and −180°, and the previous current state value of −150°, to determine a current state value of −120° (−210°→−180°→−150°→−120°), which is within the range. Client device 210 may continue to calculate current state values for additional iterations, as shown. In this way, client device 210 may reduce or eliminate errors associated with using historical state values to calculate a current state value for a wrapped state.

As indicated above, FIG. 8 is provided merely as an example. Other examples are possible and may differ from what was described with regard to FIG. 8.

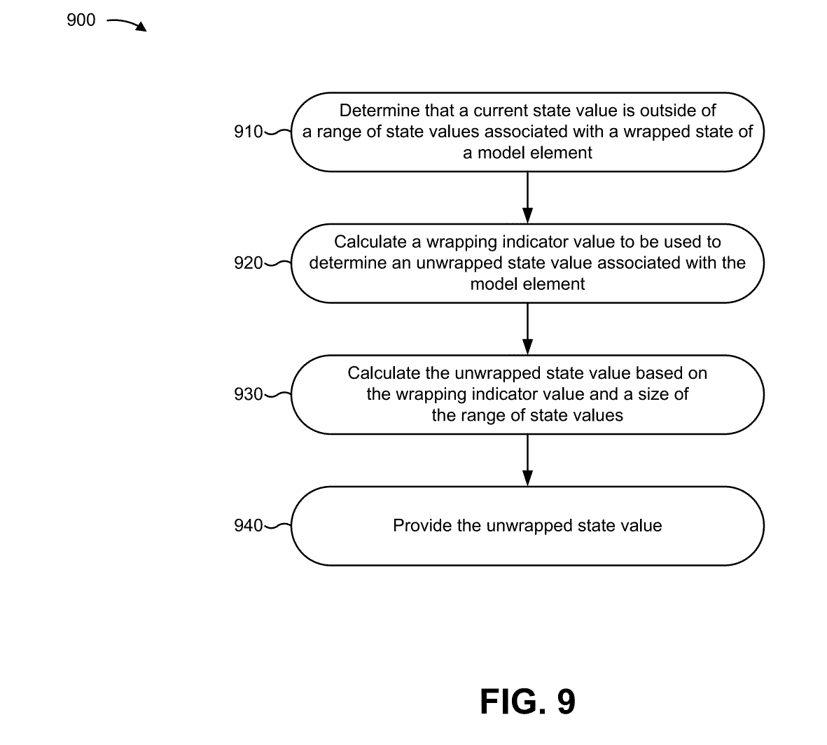

FIG. 9 is a flow chart of an example process 900 for determining an unwrapped state value based on a wrapping indicator value. In some implementations, one or more process blocks of FIG. 9 may be performed by client device 210. In some implementations, one or more process blocks of FIG. 9 may be performed by another device or a group of devices separate from or including client device 210, such as server device 230.

As shown in FIG. 9, process 900 may include determining that a current state value is outside of a range of state values associated with a wrapped state of a model element (block 910), and calculating a wrapping indicator value to be used to determine an unwrapped state value associated with the model element (block 920). For example, client device 210 may determine that a current state value is outside of a range of state values associated with a wrapped state of a model element, as described herein in connection with FIG. 7. Based on the determination, client device 210 may calculate a wrapping indicator value to be used to determine an unwrapped state value associated with the model element.

A wrapping indicator value may refer to a value that may be used to determine an unwrapped state value, associated with a model element, from a wrapped state value (e.g., a current state value), associated with the model element. A wrapped state value may refer to a current state value that has been modified (e.g., during at least one iteration of a series of iterations) to fall within a range of state values associated with the wrapped state. For example, a wrapped state value may refer to a modified current state value, discussed herein in connection with FIG. 7. An unwrapped state value may refer to an unmodified current state value that represents an actual value of the wrapped state without any modifications (e.g., without modifying a current state value during any iterations).

In some implementations, the wrapping indicator value may be an integer value, and client device 210 may initialize the wrapping indicator value to zero (e.g., at the start of model execution and/or simulation). When client device 210 determines that a current state value exceeds an upper boundary value of the range of state values, client device 210 may increment the wrapping indicator value (e.g., by adding one to the wrapping indicator value). When client device 210 determines that a current state value exceeds a lower boundary value of the range of state values, client device 210 may decrement the wrapping indicator value (e.g., by subtracting one from the wrapping indicator value).

In some implementations, client device 210 may determine a largest integer value N, where the product of N−1 and the size of the range is less than the difference between the current state value and the closest boundary value of the range (e.g., the upper boundary or the lower boundary, whichever is closer to the current state value). When client device 210 determines that a current state value exceeds an upper boundary value of the range, client device 210 may increment the wrapping indicator value by N. When client device 210 determines that a current state value exceeds a lower boundary value of the range of state values, client device 210 may decrement the wrapping indicator value by N.

For example, given a range size of 360° (e.g., from 0° to 359°, from 0° to 360° where 0°=360°, etc.), client device 210 may determine a current state value of −100°. Client device 210 may determine that N=1 since 1−1=0, and 0×360°=0° is less than the difference between −100° and 0° (e.g., 0°<100°) (N cannot equal 2 since 2−1=1, and 1×360°=360°, which is greater than 100°). Since −100° exceeds (e.g., is less than) the lower boundary value of 0°, client device 210 may decrement the wrapping indicator value by N=1. Assuming that the wrapping indicator value is initially set to zero, client device 210 may set the wrapping indicator value to −1.

Assume that at a later iteration, client device 210 determines the current state value to be 1000°. Client device 210 may determine that N=2 since 2−1=1, and 1×360°=360° is less than the difference between 1000° and 360° (e.g., 360°<640°) (N cannot equal 3 since 3−1=2, and 2×360°=720°, which is greater than 640°). Since 1000° exceeds (e.g., is greater than) the upper boundary value of 360°, client device 210 may increment the wrapping indicator value by N=2. Assuming that the wrapping indicator value is equal to −1 based on the scenario described in the preceding paragraph, client device 210 may set the wrapping indicator value to 1 (−1+2=1).

In some implementations, client device 210 may perform a Nyquist diagnostic based on calculating the wrapping indicator. For example, client device 210 may provide an indication that the sample size is too large if the wrapping indicator satisfies a threshold value (e.g., is greater than or equal to two, indicating that at least two cycles have occurred between samples).

As further shown in FIG. 9, process 900 may include calculating the unwrapped state value based on the wrapping indicator value and a size of the range of state values (block 930). For example, client device 210 may calculate the unwrapped state value using the wrapping indicator and the size of the range of state values (e.g., a difference between the upper boundary value and the lower boundary value).

In some implementations, client device 210 may calculate a product of (e.g., may multiply) the wrapping indicator value and the size of the range of values, and may add the calculated product to a current state value to determine the unwrapped state value. For example, given a range size of 360°, client device 210 may determine a current state value of −100°. Client device 210 may set the wrapping indicator value to −1, as explained in the example described above in connection with block 920. Client device 210 may determine a modified current state value of 260° (360°−100°=260°). Client device 210 may calculate the unwrapped state value by calculating a product of the wrapping indicator value (−1) and the size of the range (360°), and adding the product (−360°) to the modified current state value (260°) to determine the unwrapped state value (−100°).

Additionally, or alternatively, client device 210 may use a previous unwrapped state value to calculate a current unwrapped state value. For example, in a later iteration, client device 210 may determine a current state value of 1000°. Client device 210 may set the wrapping indicator value to 2, as explained in the example described above in connection with block 920. Client device 210 may determine a modified current state value of 280° (1000° modulo 360°=280°, and 0°+280°=280°). Client device 210 may calculate the unwrapped state value by calculating a product of the wrapping indicator value (2), determined for the iteration, and the size of the range (360°), and adding the product (720°) to the modified current state value (280°) to determine an intermediate unwrapped state value (1000°). Client device 210 may add the intermediate unwrapped state value (1000°) to a previous unwrapped state value (−100°) to generate a current unwrapped state value (900°), which represents the value of the state associated with the model element if no wrapping had occurred.

Additionally, or alternatively, client device 210 may use a sum of modified current state values to calculate an unwrapped state value. For example, in a first iteration described above, client device 210 determined the modified current state value to be 260°, and in a second iteration, client device 210 determined the modified current state value to be 280°. At the end of the second iteration, assume that the wrapping indicator value is equal to 1, as described above. Client device 210 may calculate a product of the wrapping indicator value (1) and the size of the range of values (360°), and may add the calculated product (360°) to a sum of the modified current state values (260°+280°=540°) to calculate the unwrapped state value (540°+360°=900°).

In some implementations, client device 210 may perform a modulo operation to bring the sum of the modified current state values within the range (e.g., to generate a range reduced sum), and may modify the wrapping indicator value accordingly. When the sum of the modified current state values exceeds the upper boundary of the range, client device 210 may increment the wrapping indicator value (e.g., by N, determined as described elsewhere herein, but using the sum of the modified current state values rather than the current state value). When the sum of the modified current state values exceeds the lower boundary of the range, client device 210 may decrement the wrapping indicator value (e.g., by N). Continuing with the example above, client device 210 may perform a modulo operation to bring the sum of the modified current state values (540°) within the range, and may set the range reduced sum value equal to 180° (540° modulo 360°=180°, and 0°+180°=180°). Client device 210 may increment the wrapping indicator value to 2 based on the sum of the modified current state values exceeding the upper boundary value of the range. Client device 210 may calculate a product of the wrapping indicator value (2) and the size of the range of values (360°), and may add the calculated product (720°) to the range reduced sum value (180°) to calculate the unwrapped state value (720°+180°=900°).

While particular techniques have been described herein to calculate the unwrapped state value, other techniques may be used in some implementations.

As further shown in FIG. 9, process 900 may include providing the unwrapped state value (block 940). For example, client device 210 may provide the unwrapped state value for display, for storage, and/or for further processing.

In some implementations, client device 210 may receive a request (e.g., from a user and/or a device) for the unwrapped state value, and may provide the unwrapped state value for display. For example, a user may wish to know the unwrapped state value of a model element. The user may interact with an input mechanism (e.g., provided via a user interface, such as TCE 220, of client device 210) associated with providing the unwrapped state value, and client device 210 may provide the unwrapped state value for display based on the user interaction.

Additionally, or alternatively, client device 210 may store the unwrapped state value and/or may provide the unwrapped state value for further processing. For example, client device 210 may provide the unwrapped state value for determination of another unwrapped state value (e.g., associated with a next iteration of a simulation). Additionally, or alternatively, client device 210 may trigger an event based on the unwrapped state value satisfying a threshold.

Although FIG. 9 shows example blocks of process 900, in some implementations, process 900 may include additional blocks, fewer blocks, different blocks, or differently arranged blocks than those depicted in FIG. 9. Additionally, or alternatively, one or more of the blocks of process 900 may be performed in parallel.

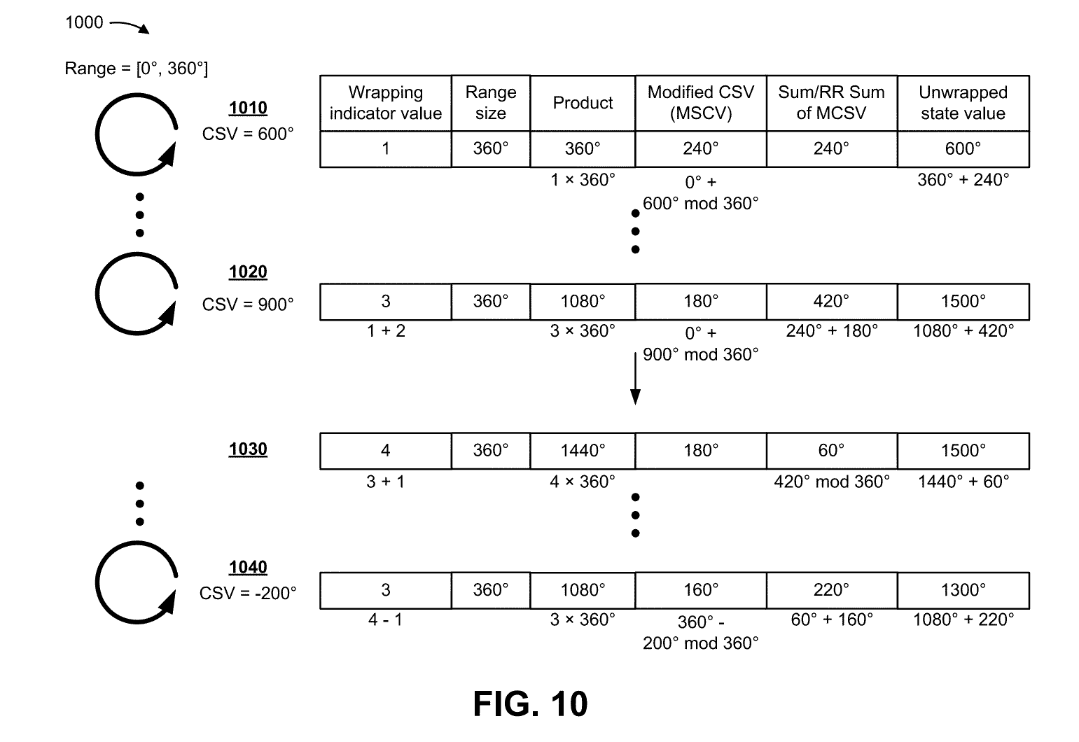

FIG. 10 is a diagram of an example implementation 1000 relating to example process 900 shown in FIG. 9. For example implementation 1000, assume that client device 210 calculates current state values for a wrapped state with a range of [0°, 360°], and a range size of 360°.

As shown by reference number 1010, during a first iteration of a simulation, assume that client device 210 determines a current state value (CSV) of 600°. Based on the current state value, client device 210 calculates a wrapping indicator value of 1, determines the range size of 360°, and calculates a product of the wrapping indicator (1) and the range size (360°) as 360° (1×360°=360°). Further, client device 210 calculates a modified current state value (MCSV) of 240° (0°+600° modulo 360°=240°), which is also equal to the sum of the modified current state values (e.g., during a first iteration). As further shown, client device 210 calculates an unwrapped state value of 600° using the product (360°) and the modified current state value (240°)(360°+240°=600°).

As shown by reference number 1020, at a second iteration (e.g., occurring after the first iteration, with or without intervening iterations), assume that client device 210 determines a current state value of 900°. Based on the current state value, client device 210 adds a value of 2 to the wrapping indicator value of 1 to generate a new wrapping indicator value of 3. Client device 210 calculates a product of the wrapping indicator (3) and the range size (360°) as 1080° (3×360°=1080°). Further, client device 210 calculates a modified current state value of 180° (0°+900° modulo 360°=180°). Client device 210 adds the MCSV from the first iteration (240°) and the MCSV from the second iteration (180°) to calculate a sum of the modified current state values as 420° (240°+180°=420°). As further shown, client device 210 calculates an unwrapped state value of 1500° using the product (1080°) and the sum of the modified current state values (420°) (1080°+420°=1500°).

As shown by reference number 1030, assume that client device 210 calculates a reduced range sum (shown as “RR sum”) of the modified current state values by performing a modulo operation. As shown, client device 210 calculates the sum of the MSCVs (420°) modulo the size of the range (360°) to generate a reduced range sum of 60° (420° mod 360°=60°). As further shown, based on calculating the reduced range sum, client device 210 increments the wrapping indicator value of 3 by a value of 1 to generate a new wrapping indicator value of 4. Client device 210 calculates a new product of 1440° (4×360°=1440°), and calculates the unwrapped state value of 1500° by adding the product (1440°) and the reduced range sum (60°) (1440°+60°=1500°).

As shown by reference number 1040, at a third iteration (e.g., occurring after the second iteration, with or without intervening iterations), assume that client device 210 determines a current state value of −200°. Based on the current state value, client device 210 subtracts a value of 1 from the wrapping indicator value of 4 to generate a new wrapping indicator value of 3. Client device 210 calculates a product of the wrapping indicator (3) and the range size (360°) as 1080° (3×360°=1080°). Further, client device 210 calculates a modified current state value of 160° (360°-200° modulo 360°=160°). Client device 210 adds the reduced range sum calculated after the second iteration (60°) and the MCSV from the third iteration (160°) to calculate a new reduced range sum of 220° (60°+160°=220°). As further shown, client device 210 calculates an unwrapped state value of 1300° using the product (1080°) and the sum of the modified current state values (220°) (1080°+220°=1300°). The unwrapped state value of 1300° represents the state associated with the model element after the third iteration is simulated, had no wrapping occurred (e.g., had no modified current state values been calculated during any iterations).

As indicated above, FIG. 10 is provided merely as an example. Other examples are possible and may differ from what was described with regard to FIG. 10.

The foregoing disclosure provides illustration and description, but is not intended to be exhaustive or to limit the implementations to the precise form disclosed. Modifications and variations are possible in light of the above disclosure or may be acquired from practice of the implementations.

As used herein, component is intended to be broadly construed as hardware, firmware, or a combination of hardware and software.

As used herein, code or program code is to be broadly interpreted to include text-based code that may not require further processing to execute (e.g., C++ code, Hardware Description Language (HDL) code, very-high-speed integrated circuits (VHSIC) HDL (VHDL) code, Verilog, Java, and/or other types of hardware or software based code that may be compiled and/or synthesized); binary code that may be executed (e.g., executable files that may directly be executed by an operating system, bitstream files that can be used to configure a field programmable gate array (FPGA), Java byte code, object files combined together with linker directives, source code, makefiles, etc.); text files that may be executed in conjunction with other executables (e.g., Python text files, a collection of dynamic-link library (DLL) files with text-based combining, configuration information that connects pre-compiled modules, an extensible markup language (XML) file describing module linkage, etc.); etc. In one example, program code may include different combinations of the above-identified classes (e.g., text-based code, binary code, text files, etc.). Additionally, or alternatively, program code may include code generated using a dynamically-typed programming language (e.g., the M language, a MATLAB® language, a MATLAB-compatible language, a MATLAB-like language, etc.) that can be used to express problems and/or solutions in mathematical notations. Additionally, or alternatively, program code may be of any type, such as a function, a script, an object, etc., and a portion of program code may include one or more characters, lines, etc. of the program code.

Some implementations are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc. Furthermore, one or more of these phrases, as used herein, may be used interchangeably. For example, “greater than a threshold” may be used interchangeably with “greater than or equal to a threshold.”

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
determine a set of historical state values to be used to calculate a current state value of a wrapped state associated with a model element,
the wrapped state being associated with a range of state values;
calculate the current state value of the wrapped state based on the set of historical state values;
determine that the current state value is outside of the range of state values;
generate a modified current state value based on determining that the current state value is outside of the range of state values,
the modified current state value being within the range of state values; and
modify at least one historical state value, of the set of historical state values, based on determining that the current state value is outside of the range of state values,
the at least one historical state value being modified based on the current state value and the modified current state value.

2. The device of claim 1, where the one or more processor are further to:
determine a solver to be used to calculate the current state value;
determine a quantity of historical state values based on the solver;
where the one or more processors, when determining the set of historical state values, are further to:
determine the set of historical state values based on the quantity of historical state values; and
where the one or more processors, when calculating the current state value, are further to:
calculate the current state value using the solver.

3. The device of claim 2, where the solver includes at least one of:
an ordinary differential equation solver, or
a differential algebraic equation solver;
where the current state value and the set of historical state values represent integration calculations performed by the solver at a series of time steps; and
where the one or more processors, when providing or storing the modified current state value and the at least one modified historical state value, are further to:
perform an integration calculation at a subsequent time step that follows the series of time steps,
the integration calculation being performed using the solver, the modified current state value, and the at least one modified historical state value.

4. The device of claim 1, where the one or more processors, when generating the modified current state value, are further to:
determine a size of the range of state values;
perform a modulo operation using the current state value and the size of the range of state values; and
generate the modified current state value based on performing the modulo operation.

5. The device of claim 1, where the one or more processors, when modifying the at least one historical state value, are further to:
determine a size of the range of state values; and
modify the at least one historical state value based on the size of the range of state values.

6. The device of claim 1, where the one or more processors, when generating the modified current state value, are further to:
determine a size of the range of state values;
determine a first boundary value of the range of state values;
determine a second boundary value of the range of state values;
determine a difference amount by which the current state value exceeds the first boundary value;
generate a modulo value by calculating the difference amount modulo the size of the range of state values; and
generate the modified current state value based on the second boundary value and the modulo value.

7. The device of claim 1, where the one or more processors are further to:
provide or store the modified current state value and the at least one modified historical state value.

8. A computer-readable medium storing instructions, the instructions comprising:
one or more instructions that, when executed by one or more processors, cause the one or more processors to:
determine that a model element is associated with a wrapped state,
the wrapped state being associated with a range of potential state values;
determine the range of potential state values associated with the wrapped state;
determine a plurality of historical state values to be used to calculate a current state value of the wrapped state at a current time step;
calculate the current state value of the wrapped state based on the plurality of historical state values;
determine that the current state value is outside of the range of potential state values;
generate a modified current state value based on determining that the current state value is outside of the range of potential state values,
the modified current state value being within the range of potential state values;
modify one or more historical state values, of the plurality of historical state values, based on determining that the current state value is outside of the range of potential state values; and
provide or store the modified current state value and the one or more modified historical state values.

9. The computer-readable medium of claim 8, where the one or more instructions, that cause the one or more processors to determine the range of potential state values, further cause the one or more processors to:
determine the range of potential state values based on at least one of:
user input that identifies the range of potential state values, or
user input that identifies the model element, where the model element is associated with a default range of potential state values.

10. The computer-readable medium of claim 8, where the range of potential state values represent angles of at least a portion of a circle.

11. The computer-readable medium of claim 8, where the one or more instructions, that cause the one or more processors to determine that the model element is associated with the wrapped state, further cause the one or more processors to:
determine that the model element is associated with at least one of:
a cyclic state, or
a periodic state;
where the one or more instructions further cause the one or more processors to:
perform a trim operation to determine a steady-state operating point associated with a model that includes the model element; and
when the one or more instructions cause the one or more processors to determine that the model element is associated with the cyclic state:
determine a value associated with the cyclic state when performing the trim operation; or
when the one or more instructions cause the one or more processors to determine that the model element is associated with the periodic state:
ignore a value associated with the periodic state when performing the trim operation.

12. The computer-readable medium of claim 8, where the one or more instructions, that cause the one or more processors to determine that the model element is associated with the wrapped state, further cause the one or more processors to:
determine that the model element is associated with the wrapped state based on at least one of:
user input that specifies that the model element is to be associated with the wrapped state, or
user input that identifies the model element, where the model element is associated with the wrapped state by default.

13. The computer-readable medium of claim 8, where the one or more instructions further cause the one or more processors to:
determine a solver to be used to calculate the current state value,
the solver including at least one of:
an ordinary differential equation solver, or
a differential algebraic equation solver;
where the current state value and the plurality of historical state values represent calculations performed by the solver at a series of time steps,
the series of time steps including the current time step; and
where the one or more instructions, that cause the one or more processors to provide or store the modified current state value and the one or more modified historical state values, further cause the one or more processors to:
perform a calculation at a subsequent time step that follows the current time step,
the calculation being performed using the solver, the modified current state value, and the one or more modified historical state values.

14. The computer-readable medium of claim 8, where the one or more instructions, that cause the one or more processors to modify the one or more historical state values, further cause the one or more processors to:
determine a size of the range of potential state values; and
modify the one or more historical state values based on the size of the range of potential state values.

15. A method, comprising:
calculating a first state value of a wrapped state associated with a model element, the wrapped state being associated with a range of state values,
the calculating the first state value being performed by a device;
determining that the first state value is outside of the range of state values,
the determining being performed by the device;
generating a modified first state value based on determining that the first state value is outside of the range of state values,
the modified first state value being within the range of state values,
the generating being performed by the device;
modifying a historical state value based on determining that the first state value is outside of the range of state values,
the historical state value being used to calculate the first state value,
the modifying being performed by the device; and
calculating a second state value based on the modified first state value and the modified historical state value,
the calculating the second state value being performed by the device.

16. The method of claim 15, where modifying the historical state value further comprises:
determining a first distance between the historical state value and the current state value; and
modifying the historical state value such that a second distance, between the modified historical state value and the modified current state value, is equal to the first distance.

17. The method of claim 15, further comprising:
determining that the second state value satisfies a threshold; and
triggering an event based on determining that the second state value satisfies the threshold.

18. The method of claim 15, where modifying the historical state value further comprises:
determining a difference between the first state value and the modified first state value; and
modifying the historical state value based on the difference between the first state value and the modified first state value.

19. The method of claim 15, further comprising:
modifying a wrapping indicator value used to determine an unwrapped state value associated with the model element, based on determining that the first state value is outside of the range of state values;
determining a size of the range of state values; and
determining the unwrapped state value based on the wrapping indicator value and the size of the range of state values.

20. The method of claim 19, where modifying the wrapping indicator value further comprises:
determining an upper boundary value of the range of state values;
determining a lower boundary value of the range of state values; and
when the first state value exceeds the upper boundary, increasing the wrapping indicator value, or
when the first state value exceeds the lower boundary, decreasing the wrapping indicator value.
